(19) United States
(12) Patent Application Publication
(10) Pub. No.: US 2026/0368466 A1
(43) Pub. Date: Nov. 19, 2026

(54) Systems and Methods Based on Collective Magnetic Memory Effects in Organo-Metallic Microparticle Ensembles

(71) Applicants: Itai CARMELI, Tel Aviv (IL); Shachar RICHTER, Rehovot (IL)

(72) Inventors: Itai CARMELI, Tel Aviv (IL); Shachar RICHTER, Rehovot (IL)

(21) Appl. No.: 19/670,135

(22) Filed: May 7, 2026

Related U.S. Application Data
(60) Provisional application No. 63/806,046, filed on May 15, 2025.

(51) Int. Cl. G06K 19/06

(52) U.S. Cl. CPC G06K 19/06084; G06K 19/0615

(57) ABSTRACT

A system is described for transmitting information or triggering mechanical action between two separated fluidic containers containing matched ensembles of magnetically preconditioned organo-metallic microparticles. After synthesis and exposure to a magnetic field, the particle ensembles spontaneously reform distinctive macroscopic structures. A stimulus applied to one container causes a detectable change in the other, even when electromagnetic shielding or physical barriers are present. Information can be transmitted by encoding inputs into particle configurations and decoding them via pattern recognition. In mechanical applications, the reconfiguration induces physical displacement of a membrane or actuator. The same materials exhibit self-restoring behavior, reforming their original structure after redispersion. The invention enables secure communication, remote actuation, and shape-memory behavior in fluidic systems at room temperature without classical signal coupling.

### CROSS REFERENCE TO RELATED APPLICATIONS

This application claims the benefit of priority of U.S. Provisional Patent Application No. 63/806,046, filed May 15, 2025, and of U.S. Provisional Patent Application No. 63/946,239, filed Dec. 22, 2025, the contents of which are all incorporated herein by reference in their entirety.

### FIELD OF THE INVENTION

This disclosure relates to systems and methods for information transfer, mechanical actuation, and material memory using microparticles comprising chiral organo-metallic compounds exhibiting collective memory effects. The invention is particularly concerned with the generation, use, and interaction of such particles in fluidic environments under controlled external stimuli, and with the exploitation of their observed long-range interactive behavior.

### BACKGROUND

Systems for transmitting information, actuating mechanical components, and storing material states typically rely on conventional electromagnetic, electrical, optical, mechanical, or chemical coupling mechanisms. In many applications, such mechanisms require wired connections, radiated signals, direct mechanical linkage, or a classical transmission path between a source location and a receiving or actuated location.

Detectable changes, information-bearing outputs, mechanical responses, or material memory effects are typically not generated at a spatially separated location from an input stimulus without conventional wired, radiative, or mechanical coupling between the relevant locations.

### SUMMARY

According to an aspect of the present invention, there is provided a system for remotely transmitting information. The system includes a first ensemble of microparticles including chiral organo-metallic compounds dispersed in a fluid medium within a first container, and a second ensemble of microparticles including the same chiral organo-metallic compounds dispersed in a fluid medium within a second container located at a distance from the first container. The system further includes a stimulus application device configured to apply a predefined external field or energy input to the first ensemble of microparticles so as to induce a structural reorganization of the microparticles in the first container, a sensor assembly positioned to monitor the second ensemble of microparticles and detect a structural configuration of the microparticles therein, and a data analysis component operatively coupled to the sensor assembly and configured to process signals corresponding to the structural configuration and generate an output indicative of a value associated with the applied stimulus. The first and second ensembles originate from a common precursor mixture that has been subjected to a magnetic preconditioning process prior to separation into the first and second containers, and application of the stimulus to the first container induces a corresponding detectable reorganization of the microparticles in the second container, thereby enabling transmission of information from the first container to the second container.

According to another aspect of the present invention, there is provided a method for remotely transmitting information using spatially separated ensembles of chiral microparticles. The method includes preparing a precursor mixture including chiral organo-metallic compounds in a fluid medium, subjecting the precursor mixture to a magnetic preconditioning process, separating the preconditioned mixture into a first container and a second container, each containing an ensemble of microparticles dispersed in fluid, applying a predefined external field or energy input to the microparticles in the first container so as to induce a structural reorganization of the microparticles therein, monitoring the microparticles in the second container to detect a resulting structural configuration of the microparticles, and processing data corresponding to the detected structural configuration to derive an informational value associated with the applied stimulus. The applied stimulus to the microparticles in the first container causes the microparticles in the second container to undergo a corresponding structural reorganization that is remotely detectable and correlated with the applied stimulus.

According to another aspect of the present invention, there is provided a method for preparing a pair of microparticle ensembles exhibiting collective memory and long-range interactive behavior. The method includes providing a precursor solution including a chiral organic compound and a metal salt in a solvent system under conditions suitable for forming organo-metallic microparticles, allowing formation of microparticles including chiral organo-metallic compounds dispersed in the solution, subjecting the solution containing the microparticles to a magnetic field for a duration sufficient to induce a collective memory state, separating the magnetically preconditioned solution into first and second portions each containing a respective ensemble of microparticles, and storing the first and second portions separately in fluid-containing vessels suitable for subsequent use in communication, actuation, or sensing systems.

### BRIEF DESCRIPTION OF THE DRAWINGS

The invention is herein described, by way of example only, with reference to the accompanying drawings, wherein:

FIG. 1 is a flow diagram illustrating a process for synthesizing preconditioned microparticle ensembles and applying them in either an information transmission system or a mechanical actuation system. The diagram includes steps for preparing the precursor solution, synthesizing the microparticles, magnetic preconditioning, and dividing the solution into portions. Downstream application paths are shown for data sensing and mechanical output, respectively.

FIG. 2 is a schematic diagram of a system for remote information transmission and secure communication. The system includes a first container of preconditioned microparticles, a stimulus application device, a second container separated by a physical barrier, and a sensor assembly with an associated processing system and data output. Optional components include a magnetic shielding enclosure and an external data input.

FIG. 3 is a schematic diagram of a system for remote mechanical actuation. The system includes a first container of preconditioned microparticles, a stimulus application device, a second container, and an actuator assembly comprising a diaphragm and an actuated element coupled to a mechanical output. An external input is provided to control the stimulus applied to the first container.

### DESCRIPTION OF THE PREFERRED EMBODIMENTS

As part of this application, experimental observations, particle synthesis protocols, and supporting image data are incorporated in the following appendices:
Appendix A: Scientific Disclosure—Emerging Non-Local Quantum Phenomena in a Classical System of Organo-Metallic Microparticles
Appendix B: Supplementary Information—Photographic and Spectroscopic Records of Experimental Results
Appendix C: further examples illustrating non-local quantum phenomena including the use of a local electric field stimulus at a first location generating detectable changes at a second location.

The content of the appendices forms part of the present disclosure and may be referenced for purposes of illustration and support of the described systems and methods, and claims relating thereto. The structural and functional systems, flow diagrams, and exemplary implementations detailed herein build upon and apply the physical phenomena described in the appended documents.

### New Class of Long-Range Interactive Behavior in Organo-Metallic Microparticles

The inventors have discovered a novel class of physical behavior in organo-metallic microparticles that exhibit both a collective magnetic memory effect and non-local coupling interactions across spatial separations. These effects, not previously known or predicted in classical or mesoscopic systems at ambient conditions, manifest in chiral particle suspensions that spontaneously reorganize into reproducible macroscopic shapes, and influence the behavior of remote, matched suspensions without conventional electromagnetic interaction. These discoveries provide the basis for the systems and methods described in this application.

Thus, as detailed in the attached Appendices, the inventors have demonstrated that certain chiral organo-metallic microparticles in aqueous suspension, when synthesized under defined conditions and exposed to magnetic preconditioning, exhibit a remarkable and reproducible Collective Memory Effect (CME). This effect is characterized by the spontaneous reformation of macroscopic structures by dispersed particles, reproducing configurations that previously emerged under magnetic field exposure, even after thorough mechanical mixing and container transfer.

Further, a related phenomenon of long-range non-local coupling has been observed between physically separated ensembles of such particles. Two matched suspensions, derived from a common preconditioned batch and separated by distances of up to several meters, exhibit coordinated or complementary structural reconfigurations in response to stimuli applied to only one of the two containers. The coupling persists even when magnetic and electric field shielding (e.g., μ-metal enclosures) is used to isolate the second container, suggesting that the observed effect is not due to classical electromagnetic transmission.

These behaviors suggest a novel class of material interactions operating through mechanisms that allow non-classical signal transmission and distributed structural organization. Notably, the shape transformations in the second container can:
Reflect distinct changes in spatial configuration corresponding to the stimulus pattern in the first container;
Trigger mechanical displacement of adjacent physical structures;
Reconstruct prior shapes autonomously, demonstrating a form of material-level memory.

These observed phenomena serve as the physical basis for the systems and methods described herein, enabling a new class of data transmission, remote actuation, and self-restoring material applications.

### Preparation of Preconditioned Microparticle Ensembles

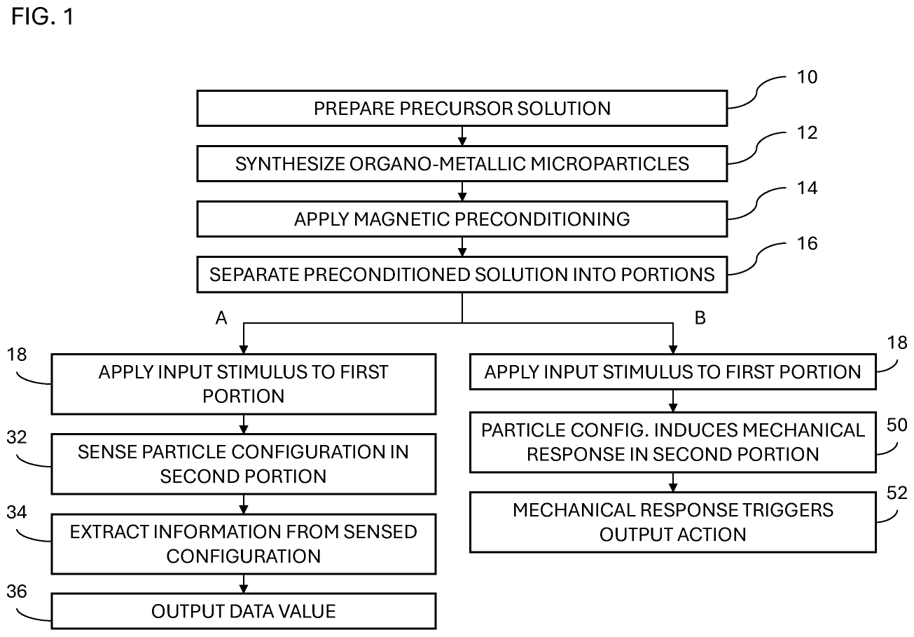

Organo-metallic microparticles capable of exhibiting long-range interactive behavior and collective memory effects are prepared from chiral organic compounds in the presence of metal salts under controlled solution-phase synthesis conditions. A representative synthesis process is depicted in steps 10-16 of FIG. 1.

In step 10, a precursor solution is prepared by dissolving a chiral organic compound in a solvent medium. A representative example involves the dissolution of cinchonine or cinchonidine in deionized water. Optional additives, such as pH buffers or dispersing agents, may be included to support colloidal stability.

In step 12, a metal salt is added to the solution under ambient or mildly elevated temperatures with stirring. The metal salt may comprise silver nitrate (AgNO₃) in one exemplary embodiment. Under these conditions, spontaneous nucleation and growth of microparticles occur, yielding suspended structures containing metal-organic hybrid phases with embedded chiral ligands.

In step 14, the suspension of microparticles is subjected to magnetic preconditioning. In one example, the solution is placed atop a permanent magnet having a field strength of approximately 1 Tesla for a duration of 12 to 24 hours. During this interval, the particles self-organize into large-scale macroscopic shapes (such as rings, clusters, or arrows), which are believed to encode a persistent structural memory within the particle ensembles. In some cases, the macroscopic shape may be recorded, for example, by using a camera to generate a photographic reference image, which may be useful in subsequent system design and/or as an input for image processing as a prediction of the memory-effect macroscopic shape against which subsequent perturbed or unperturbed re-formed shapes can be compared.

In step 16, the preconditioned solution is divided into two or more portions, each constituting a matched ensemble of microparticles derived from the same precursor and field history. These portions may be placed into separate containers for subsequent use in communication, actuation, or memory-based systems. After preparation and division into matched ensembles, it has been observed that the microparticles in each container spontaneously reorganize over time to reform the macroscopic structure that emerged during magnetic preconditioning.

It is believed that the collective behavior of these particles arises from spin-dependent interactions, exchange-like coupling, or field-enhanced van der Waals effects, facilitated by the chiral environment at the particle surface. While silver-based systems with cinchona alkaloids have been verified experimentally, it is believed that other combinations of chiral organic ligands and transition metal ions (e.g., copper, palladium, platinum, or gold) may exhibit similar preconditioning behavior and long-range coupling. Candidate organic molecules may include other alkaloids, amino acid derivatives, or chiral amines capable of coordinating metal centers in solution.

### Applications in Remote Information Transmission

The systems and methods described herein enable a novel form of information transmission that does not rely on conventional electromagnetic signaling, electrical wiring, or mechanical coupling between transmitter and receiver elements. Instead, the inventive system uses two physically separated particle ensembles, each comprising preconditioned microparticles synthesized and processed as described in steps 10 through 16 of FIG. 1, where both particle ensembles have been allowed to revert spontaneously (without applied fields) to their preconditioned distinctive macroscopic observable shape. A stimulus subsequently applied to one ensemble has been found to result in a detectable change in the other, without direct physical or classical field-based interaction.

This phenomenon enables a class of communication systems in which a user-defined input stimulus induces a spatial reorganization of particles in a remote container. The resulting shape change or pattern formation may be observed by a sensor system and converted into a digital output, thereby encoding and transmitting information across space using material-level reconfiguration.

Such systems may find application in:
Secure or line-of-sight-independent signaling between isolated environments,
Field-deployable sensor networks where classical RF transmission is impractical,
Analog-to-digital pattern encoding schemes for low-bandwidth, high-integrity data transmission,
Foundation modules for room-temperature quantum-mimetic networks.

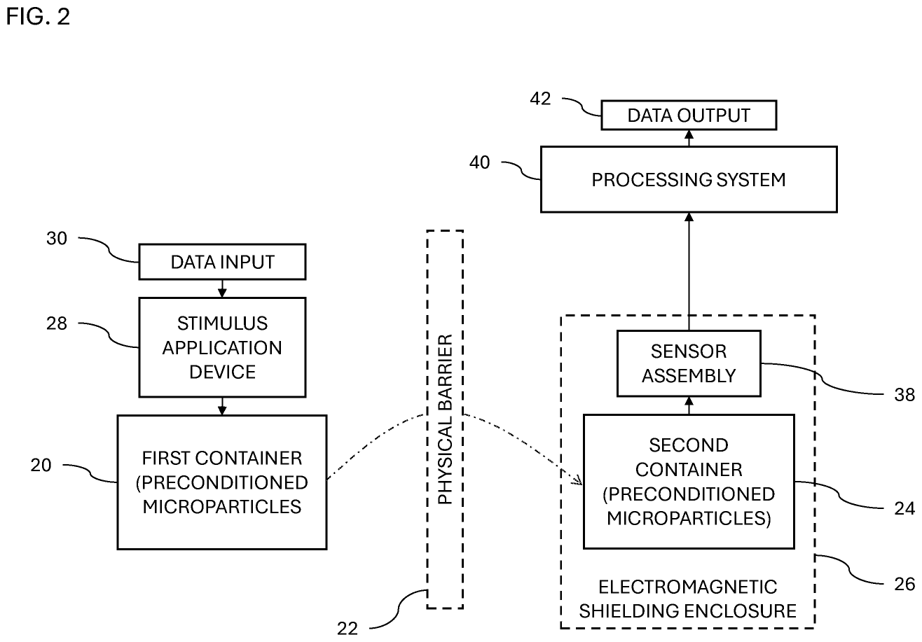

An example system for remote information transmission is shown in FIG. 2. Matched microparticle ensembles are prepared and stored in a first container (20) and a second container (24), respectively, and are allowed to re-form the macroscopic structure that emerged during magnetic preconditioning.

A stimulus application device (28) is positioned in proximity to the first container (20) and is controlled by a data input (30). This input may comprise a signal corresponding to a binary or multi-symbol data value. Depending on the input, the stimulus application device (28) generates a magnetic, electrical, or chemical perturbation to the first container (20). This operation corresponds to step 18 of FIG. 1.

The input stimulus is applied in a manner that results in a visible modification of the macroscopic spatial configuration of the microparticle ensemble in the first container. This has been observed to result in the matched microparticles in the second container (24) undergoing a corresponding change in spatial configuration, without any direct connection or classical field propagation between them.

The second container is monitored by a sensor assembly (38). The sensor assembly may include an optical imaging system, capacitive sensor, or other suitable transduction modality capable of detecting macroscopic particle reorganization. Sensor output is passed to a processing system (40) which classifies the observed shape pattern. The output of the processing system is delivered as a data output (42), representing the logical value (e.g., bit state or pattern code) corresponding to the stimulus applied to the first container. This sequence is reflected by steps 32, 34, and 36 of Path A in FIG. 1.

Since different types of stimuli to the first container and corresponding perturbations generate corresponding differentiable changes in the second container, it is possible to encode an absolute value of a single bit (i.e., a zero or a one), or multiple bits of information, in data input (30) as corresponding differing stimuli or combinations of stimuli by stimulus application device (28), and to decode those multiple bits by identifying the corresponding responses in the second container.

Although illustrated herein in the context of unidirectional transmission, the symmetry of the solutions allows each to be used both as the “transmitter” container and as the “receiver” container, and may thus be used for bidirectional communication. A bidirectional arrangement will employ both the input/stimulus components and the sensing/output components at each location. Algorithms may be developed for distinguishing between a locally induced perturbation through the local stimulus and a response to a stimulus applied to a paired solution remotely.

Additionally, although illustrated herein as a pair of coupled solutions providing point-to-point communication, other implementations may subdivide the solution into three or more portions, allowing multi-point communication, where an input at one location generates outputs at two or more remote locations.

The described system thus provides a concrete and repeatable method for transmitting symbolic data across spatial separation using preconditioned particle ensembles. The absence of radiated signals or wires enables applications in environments where conventional communication methods are impractical or undesirable. The use of direct input (30) and interpretable output (42) further ensures that the system may be integrated into broader control, monitoring, or communication frameworks.

Following the principles described above, the system shown in FIG. 2 may also be adapted for use in secure communication applications, where the second container is physically isolated or shielded to prevent classical coupling.

In such configurations, the second container 24 may be positioned beyond a physical barrier 22 and/or optionally enclosed within a magnetic shielding enclosure 26 (e.g., a μ-metal enclosure or other structure that limits ambient magnetic and/or electromagnetic fields). These optional components are depicted in dashed lines in FIG. 2 to indicate their non-essential but advantageous nature in secure settings.

Experimental observations indicate that the structural reconfiguration of the microparticle ensemble in container 24 still occurs even when such shielding or barriers are present, and no classical transmission path is available. This suggests that the communication mechanism between containers 20 and 24 is not mediated by conventional electromagnetic or mechanical propagation.

Accordingly, the system may be used in settings requiring covert, tamper-resistant, or electromagnetically silent communication channels, including:
Secure data links across shielded compartments,
Communication between equipment in electromagnetically noisy or shielded environments,
Physically secure sensor-actuator networks without radiated emissions.

### Applications in Remote Mechanical Actuation

The observed long-range coupling behavior between matched microparticle ensembles also enables a novel class of remotely actuated mechanical systems. In these applications, the system is configured such that a mechanical element responds to a shape transformation induced in one particle ensemble by stimulus applied to its counterpart. No mechanical linkage, fluid connection, or classical electromagnetic signal is required between the two ensembles.

This class of applications may include:
Triggering of mechanical relays or switches,
Displacement of fluidic or pneumatic components (e.g., membrane pumps, valves),
Motion amplification via compliant materials,
Remote physical response in distributed sensor-actuator networks.

### Illustrative Implementation

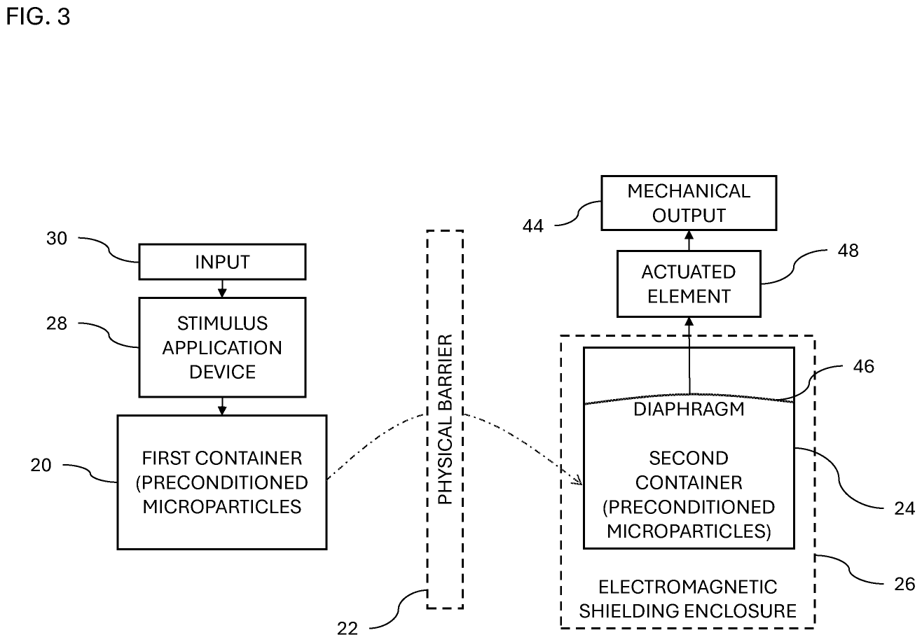

A representative system is shown in FIG. 3, wherein matched particle ensembles are stored in a first container 20 and a second container 24. The first container is stimulated by a stimulus application device 28, which receives a user-defined or external data input 30. The stimulus may comprise a magnetic or electric field input (corresponding to step 18 of FIG. 1, Path B), applied in a manner that modifies the macroscopic spatial configuration of the microparticles in container 20.

The microparticles in container 24, having previously re-formed their macroscopic structure after synthesis and preconditioning (as described in steps 10-16 of FIG. 1), are observed to undergo a corresponding structural reconfiguration in response to the applied stimulus. This reorganization, although occurring within a static fluid volume, produces a localized change in mass distribution, magnetic moment, or electrostatic potential, which can be harnessed to perform mechanical work.

In the non-limiting exemplary implementation of FIG. 3, a wall of container 24 includes a flexible diaphragm 46 positioned to respond to vertical or lateral forces induced by reorganization of the microparticle ensemble. The diaphragm is schematically illustrated here above the solution, but is typically implemented in the base of the container. The diaphragm is mechanically coupled to an actuated element 48, which may be a mechanical switch, lever, microvalve, or other responsive structure, preferably configured to be triggered to produce a change in state which results in an amplified and readily discernable mechanical output 44, such as opening of a valve, closure of an electrical contact, or movement of a tactile indicator.

The described sequence corresponds to steps 50 and 52 of Path B in FIG. 1. The use of a diaphragm allows the system to convert relatively subtle internal forces within the particle ensemble into actionable mechanical outputs, potentially amplified by compliant materials or low-force mechanisms. The mechanical output 44 may be used directly or in conjunction with downstream sensors or control logic.

Because no direct physical signal or conduit connects the stimulus source and the actuator, this system provides a basis for line-of-sight-independent mechanical control, suitable for:
Actuation across sealed compartments or barriers,
Physically isolated safety or redundancy systems,
Long-duration remote triggers requiring minimal energy or wiring.

### Applications in Self-Restoring and Memory Materials

The ability of magnetically preconditioned microparticles to autonomously reorganize into specific macroscopic structures, even after mechanical dispersion and redispersion, gives rise to a class of self-restoring material systems. These systems exhibit behavior analogous to “shape memory” or “collective memory” materials, but arise from field-programmed microparticle interactions rather than thermomechanical phase transitions.

This class of applications may include:
Self-reconfiguring structural elements,
Passive memory tags or visual indicators,
Self-healing geometries in soft robotics or implants,
Templates for programmable shape assembly or reassembly.

### Observed Behavior and Implementation

As described in steps 10 through 16 of FIG. 1, particle ensembles are synthesized, preconditioned under a magnetic field to form a macroscopic shape, and then divided into separate portions. Upon redispersion of a portion of the solution—e.g., by pipetting, stirring, or vigorous agitation—the visible structure disappears, and the particles become uniformly suspended.

Over a period of hours to days, it has been observed that the particles spontaneously reform a macroscopic configuration closely resembling the one formed during the preconditioning step. This behavior has been reproduced over multiple cycles of redispersion and reassembly, and in multiple containers derived from the same precursor solution.

This phenomenon is supported by experimental images included in Appendix B, particularly:
SI.2 and SI.3: reformation of ring-like and asymmetric structures after redispersion;
SI.4-SI.6: mirrored or complementary shape reformation between portions;
SI.13 and SI.18: long-term retention and recovery of complex geometric forms.

The reformation process occurs without further applied magnetic field, indicating that the memory is retained within the ensemble of particles themselves, likely through stable surface properties or long-range field interactions induced during preconditioning. These properties have been observed to be sustained over a period of a month or more and are believed to be persistent for extended periods. The system has been observed through multiple cycles of dispersion, each time reforming the preconditioned geometrical form.

Such systems can be embedded within fluidic or gel matrices to form structures that:
Recover a previous form after mechanical damage,
Visually indicate disturbance and then revert,
Serve as non-electronic memory elements encoding spatial information.

The self-restoring nature of these systems offers advantages for passive maintenance, tamper evidence, and autonomous system repair, particularly in low-energy or unpowered environments.

### Electric Field Stimulus

The feasibility of an electric field as the actuating stimulus at one location to induce a detectable change in a matched ensemble of microparticles at a second location is demonstrated in Appendix C where pages 1 and 2 describe the experimental setup and pages 4 and 5 show visible changes occurring in the remote shielded flask after application of an electric field and during repeat cycles of the electric field stimulus after a relaxation period. The use of an electric field as the actuating stimulus is in many ways analogous to the magnetic field stimulus illustrated extensively in Appendices A and B, but also differs therefrom in certain respects.

Firstly, observable changes in the remote ensemble of particles have been observed over relatively short time periods of application of the electric field to the local suspension, ranging from 2-3 hours down to as little as a few minutes. The elapsed time of application of the electric field for each state of the response are shown as labels next to the corresponding photographs in Appendix C.

Secondly, due to the molecules in the local solution being electrically charged and/or having electric dipoles, rearrangement of the molecules due to short-range electrostatic forces resulting from the applied electric field may overcome the shape-memory properties of the suspension, resulting in migration and/or reorientation of particles away from the shape-memory configuration to a lower energy state relative to the applied electric field. This may cause a loss of visual correspondence between the appearance of the suspension in the local vial and the remote vial. Nevertheless, it has been observed that the exposure of the molecules in the local vial to the electric field is still effective to induce a distinctive change in the visual appearance of the ensemble of microparticles in the remote vial, thereby enabling implementation of each of the applications described above using electric fields as the input stimulus.

It will be appreciated that the above descriptions are intended only to serve as examples, and that many other embodiments are possible within the scope of the present invention as defined in the appended claims.

What is claimed is:

1. A system for remotely transmitting information, comprising:
(a) a first ensemble of microparticles comprising chiral organo-metallic compounds, the microparticles being dispersed in a fluid medium within a first container;
(b) a second ensemble of microparticles comprising the same chiral organo-metallic compounds, dispersed in a fluid medium within a second container located at a distance from the first container;
(c) a stimulus application device configured to apply a predefined external field or energy input to the first ensemble of microparticles, the stimulus being selected to induce a structural reorganization of the microparticles in the first container;
(d) a sensor assembly positioned to monitor the second ensemble of microparticles and detect a structural configuration of the microparticles therein;
(e) a data analysis component operatively coupled to the sensor assembly, configured to process signals corresponding to the structural configuration and generate an output indicative of a value associated with the applied stimulus,
wherein the first and second ensembles of microparticles originate from a common precursor mixture that has been subjected to a magnetic preconditioning process prior to separation into the first and second containers,
and wherein application of the stimulus to the first container induces a corresponding detectable reorganization of the microparticles in the second container, thereby enabling transmission of information from the first container to the second container.

2. The system of claim 1, wherein the stimulus comprises application of a magnetic field having a predefined spatial geometry.

3. The system of claim 1, wherein the stimulus comprises application of an electric potential across electrodes immersed in the fluid medium.

4. The system of claim 1, wherein the stimulus comprises a chemical reagent added to the first container.

5. The system of claim 1, wherein the structural configuration is detected using an optical imaging device.

6. The system of claim 1, wherein the structural configuration is detected based on mechanical displacement of a physical member.

7. The system of claim 1, wherein the detection comprises capacitive or dielectric sensing of the particle ensemble.

8. The system of claim 1, wherein the second container is enclosed within a magnetic shielding enclosure.

9. The system of claim 1, wherein the distance between the first and second containers is at least 10 meters.

10. The system of claim 1, wherein the first and second containers are positioned in different rooms or separated by a solid wall.

11. The system of claim 1, wherein the structural configuration formed in the second container comprises a complementary or mirrored version of the configuration formed in the first container.

12. The system of claim 1, wherein the magnetic preconditioning process comprises exposure to a magnetic field of at least 0.5 Tesla for a duration of at least 12 hours.

13. The system of claim 1, wherein the magnetic preconditioning causes the microparticles to form a visible macroscopic shape in the fluid medium.

14. The system of claim 1, further comprising a physical barrier positioned between the first container and the second container, and wherein the application of the stimulus to the first container causes a corresponding detectable reorganization of the microparticles in the second container without electromagnetic wave propagation through the physical barrier.

15. A method for remotely transmitting information using spatially separated ensembles of chiral microparticles, the method comprising:
(a) preparing a precursor mixture comprising chiral organo-metallic compounds in a fluid medium;
(b) subjecting the precursor mixture to a magnetic preconditioning process;
(c) separating the preconditioned mixture into a first container and a second container, each containing an ensemble of microparticles dispersed in fluid;
(d) applying a predefined external field or energy input to the microparticles in the first container so as to induce a structural reorganization of the microparticles therein;
(e) monitoring the microparticles in the second container to detect a resulting structural configuration of the microparticles; and
(f) processing data corresponding to the detected structural configuration to derive an informational value associated with the applied stimulus,
wherein the applied stimulus to the microparticles in the first container causes the microparticles in the second container to undergo a corresponding structural reorganization that is remotely detectable and correlated with the applied stimulus.

16. A method for preparing a pair of microparticle ensembles exhibiting collective memory and long-range interactive behavior, the method comprising:
(a) providing a precursor solution comprising a chiral organic compound and a metal salt in a solvent system under conditions suitable for forming organo-metallic microparticles;
(b) allowing formation of microparticles comprising chiral organo-metallic compounds dispersed in the solution;
(c) subjecting the solution containing the microparticles to a magnetic field for a duration sufficient to induce a collective memory state;
(d) separating the magnetically preconditioned solution into first and second portions, each containing a respective ensemble of microparticles; and
(e) storing the first and second portions separately in fluid-containing vessels suitable for subsequent use in communication, actuation, or sensing systems.

17. The method of claim 16, wherein the chiral organic compound comprises Cinchonine or Cinchonidine.

18. The method of claim 16, wherein the metal salt comprises silver nitrate.

19. The method of claim 16, wherein the precursor solution further comprises a surfactant or dispersing agent.
